(19) United States
(12) Patent Application Publication
(10) Pub. No.: US 2026/0144281 A1
(43) Pub. Date: May 28, 2026

(54) METHOD OF MAKING FERMENTED PICKLE INCLUDING VARIOUS KINDS OF VEGETABLES AND FRUITS

(71) Applicant: Mi Soo Seo, Seoul (KR)

(72) Inventor: Mi Soo Seo, Seoul (KR)

(21) Appl. No.: 18/957,214

(22) Filed: Nov. 22, 2024

(51) Int. Cl. A23L 19/20; A23L 25/00

(52) U.S. Cl. CPC A23L 19/20; A23L 25/40

(57) ABSTRACT

Provided is a method of making a fermented pickle including various kinds of vegetables and fruits, the method including a vegetable ingredient preparation step for preparing various kinds of vegetables in a uniform size, a fruit ingredient preparation step for preparing various kinds of fruits in a uniform size, a sauce preparation step for preparing a sauce by mixing 100 parts by weight of vinegar, 90 to 110 parts by weight of water, 40 to 60 parts by weight of sugar, and 4 to 6 parts by weight of salt, and a primary low-temperature aging step for mixing the prepared ingredients with the sauce and aging the ingredients at 1° C. to 5° C. for 3 to 4 days. According to the present invention, various nutrients may be provided quickly and easily and sufficient amounts of nutrients may be provided due to a low acidity of vinegar.

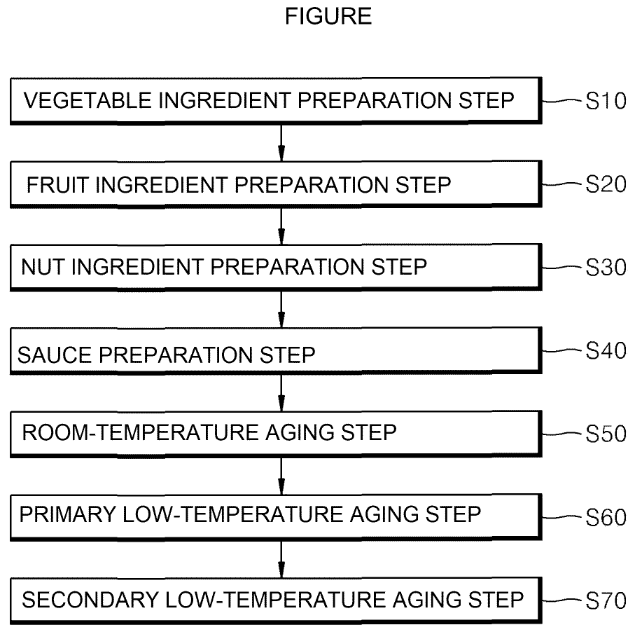

### BACKGROUND OF THE INVENTION

### 1. Field of the Invention

The present invention relates to a method of making a fermented pickle and, more particularly, to a method of making a fermented pickle capable of providing various nutrients quickly and easily, and of providing sufficient amounts of nutrients due to a low acidity.

### 2. Description of the Related Art

Jangajji is a type of traditional Korean food made by slicing vegetables such as chili peppers, garlic, and cucumbers, and then marinating and aging them in salt or traditional salty seasonings such as soy sauce, chili paste, or soybean paste for long-term storage. Jangajji is available in a wide variety of types depending on main ingredients, seasonings for marination, and recipes.

However, traditional jangajji, which uses vegetables such as chili peppers, garlic, cucumbers, and perilla leaves as main ingredients, is normally spicy and salty because seasonings with relatively strong flavors, e.g., soy sauce, soybean paste, and chili paste, are used. Thus, consuming a lot of salty jangajji at once may lead to various adult diseases. For this reason, sufficient nutrients may not be easily obtained by consuming only jangajji as a side dish, and particularly, busy modern people who do not have much time for meals prefer foods capable of providing nutrients quickly and easily.

In addition, because the types of vegetables used as main ingredients of existing jangajji are limited to chili peppers, garlic, cucumbers, perilla leaves, cabbage, etc., and one type of jangajji normally uses only one type of vegetable or fruit, the types and amounts of nutrients obtainable from one meal by consuming only existing jangajji are extremely limited.

### SUMMARY OF THE INVENTION

The present invention provides a method of making a fermented pickle capable of providing various nutrients quickly and easily, and of providing sufficient amounts of nutrients due to a low acidity of vinegar.

According to an aspect of the present invention, there is provided a method of making a fermented pickle, the method including a vegetable ingredient preparation step for preparing various kinds of vegetables in a uniform size, a fruit ingredient preparation step for preparing various kinds of fruits in a uniform size, a sauce preparation step for preparing a sauce by mixing 100 parts by weight of vinegar, 90 to 110 parts by weight of water, 40 to 60 parts by weight of sugar, and 4 to 6 parts by weight of salt, and a primary low-temperature aging step for mixing the prepared ingredients with the sauce and aging the ingredients at 1° C. to 5° C. for 3 to 4 days.

The method may further include a nut ingredient preparation step for preparing nuts in a uniform size.

The method may further include a secondary low-temperature aging step for boiling a liquid separated from the various kinds of ingredients, cooling the liquid, pouring the liquid back over the various kinds of ingredients, and then aging the ingredients at 1° C. to 5° C. for 4 to 5 days.

The various kinds of vegetables may include celery, perilla leaves, lance asiabell roots, green plums, garlic, chili peppers, ginger, radishes, onions, cabbage (or red cabbage), cucumbers, various colored bell peppers, sweet peppers, garlic stems, and rosemary.

The various kinds of fruits may include apples, sweet persimmons, pears, peaches, bananas, and kiwifruit.

### BRIEF DESCRIPTION OF THE DRAWINGS

The above and other features and advantages of the present invention will become more apparent by describing in detail embodiments thereof with reference to the attached drawings in which:

FIGURE is a flowchart of a method of making a fermented pickle, according to an embodiment of the present invention.

### DETAILED DESCRIPTION OF THE INVENTION

Hereinafter, the present invention will be described in detail by explaining embodiments of the invention with reference to the attached drawings.

FIGURE is a flowchart of a method of making a fermented pickle, according to an embodiment of the present invention.

Referring to FIGURE, the method according to an embodiment of the present invention is a method of making a fermented pickle including various kinds of vegetables and fruits, and includes a vegetable ingredient preparation step S10, a fruit ingredient preparation step S20, a nut ingredient preparation step S30, a sauce preparation step S40, a room-temperature aging step S50, a primary low-temperature aging step S60, and a secondary low-temperature aging step S70.

Initially, various kinds of vegetables such as celery, perilla leaves, lance asiabell roots, green plums, garlic, chili peppers, ginger, radishes, onions, cabbage (or red cabbage), cucumbers, various colored bell peppers, sweet peppers, garlic stems, and rosemary are washed with clean water and then cut into a uniform bite size. In this case, depending on the vegetables, peeling or pitting may be performed when needed. (The vegetable ingredient preparation step S10)

Then, various kinds of fruits such as apples, sweet persimmons, pears, peaches, bananas, and kiwifruit are washed with clean water and cut into a uniform bite size. In this case, depending on the fruits, peeling or pitting may be performed when needed. (The fruit ingredient preparation step S20)

Thereafter, nuts such as chestnuts, walnuts, and almonds are washed with clean water and cut into a uniform bite size. In this case, depending on the nuts, peeling may be performed when needed. (The nut ingredient preparation step S30)

Meanwhile, after the vegetables, the fruits, and the nuts are prepared, a sauce is prepared by boiling a mixture of 100 parts by weight of vinegar, 90 to 110 parts by weight of water, 40 to 60 parts by weight of sugar, and 4 to 6 parts by weight of salt to 100° C.

In this case, when the vinegar content is less than 100 parts by weight, the refreshing taste of the sauce is weakened, and when the vinegar content is more than 100 parts by weight, the taste of the sauce becomes excessively sour.

The vinegar may be classified into different types depending on production methods, ingredients, aging periods, etc.

The vinegar may be divided into fermented vinegar (brewed vinegar) and synthetic vinegar depending on production methods, and the fermented vinegar is classified depending on used raw materials into grain vinegar using barley, rice, etc. and fruit vinegar using grapes, apples, persimmons, etc. The synthetic vinegar is made by diluting chemically made glacial acetic acid with water and adding amino acids or sugars to enhance flavor. Currently, the synthetic vinegar is not called vinegar but called diluted acetic acid.

The vinegar includes various types of vinegar, e.g., grape vinegar, apple vinegar, rice vinegar, brown rice vinegar, black rice vinegar, beer vinegar, sugar cane vinegar, coconut vinegar, pineapple vinegar, lacquer tree vinegar, date vinegar, malt vinegar, spirit vinegar, blackcurrant vinegar, raspberry vinegar, quince vinegar, tomato vinegar, goji berry vinegar, honey vinegar, kiwifruit vinegar, malt vinegar, palm vinegar, pomegranate vinegar, raisin vinegar, wine vinegar, blueberry vinegar, blackberry vinegar, strawberry vinegar, and vinegar made from a mixture of the afore-mentioned ingredients, depending on used ingredients.

In the current embodiment, brown rice vinegar is used as the vinegar. Herein, brown rice is rich in dietary fiber, vitamin E, vitamin B6, gamma oryzanol, and octacosanol. Dietary fiber serves to purify and detoxify enterotoxins, gamma oryzanol is known to be effective in cranial nerve regulation, stroke, dementia, and blood pressure regulation, and octacosanol is known to be effective in enhancing endurance.

Vinegar is one of the four traditional fermented foods in Korea and has been used as a representative seasoning with a sour taste. There are also historical records of vinegar being used for medical purposes. [Hanyak Gugeupbang: Emergency Medicine Recipes in Local Medicinals] records that vinegar is used to treat boils and strokes, and [Donguibogam: Principles and Practice of Eastern Medicine] of the Joseon Dynasty states that vinegar is mild in nature, sour in taste, and non-toxic, and eliminates toxins from fish and vegetables.

Vinegar is known to be good for recovery from fatigue and to purify the blood by keeping it alkaline, and has various other effects such as skin care and sterilization.

In the West, it is estimated that vinegar has been used since around 5000 BC. Fruit vinegar was first made by fermenting dates in Babylonia, and was used as a seasoning, food preservation, medicine, or the like.

In the East, vinegar has been used for 3000 years, and was made by fermenting grains into alcohol, unlike fruit vinegar.

Vinegar contains eight essential amino acids, which directly or indirectly aid in wound healing and growth, prevent the destruction of various vitamins and minerals, and maintain the freshness of raw vegetables and grains. In addition, vinegar is known to purify the blood and help prevent and treat adult diseases such as diabetes and high blood pressure due to the powerful antioxidant effects of over 60 types of organic acids.

Furthermore, the organic acids in vinegar help break down lactic acid in the human body, prevent carbohydrates from turning into fat, and promote the breakdown of fat to normalize blood flow. Vinegar also contains a lot of pepchino, which is believed to protect arteries, inhibit cholesterol production, promote blood circulation, lower blood pressure, and control brain pressure, thereby preventing and treating stroke, dementia, diabetes, and Parkinson's disease. Vinegar itself acts as a digestive enzyme, increasing nutrient absorption and improving intestinal function. In other words, vinegar kills harmful bacteria including Escherichia coli in the intestines, and helps prevent constipation. The antibacterial properties of vinegar may improve intestinal health and assist in treating constipation and hemorrhoids.

Moreover, vinegar boosts immunity against cancer, particularly, liver cancer, stomach cancer, colon cancer, and breast cancer. Dr. Krebs from the UK, who received the Nobel Prize in Physiology or Medicine in 1953, discovered and reported that consuming 100 mg of naturally fermented vinegar per day can help men live 6 years longer and women 8 years longer.

When the water content is less than 90 parts by weight, the acidity of the sauce is excessively increased, and when the water content is more than 110 parts by weight, the acidity of the sauce is excessively reduced.

When the sugar content is less than 40 parts by weight, the savory taste of the sauce is excessively weakened, and when the sugar content is more than 60 parts by weight, the taste of the sauce becomes excessively sweet.

When the salt content is less than 4 parts by weight, the salty taste of the sauce is excessively weakened, and when the salt content is more than 6 parts by weight, the taste of the sauce becomes excessively salty.

Because the sauce contains more water than existing pickle sauces and harmonizes with the juice from the various kinds of vegetables and fruits, the sauce has a lower acidity than the existing pickle sauces and also has a deep flavor. (The sauce preparation step S40)

Then, the prepared sauce is poured over the prepared vegetable, fruit, and nut ingredients while the sauce is still hot, and the ingredients are sealed in an airtight container and aged at room temperature for about a day. Pouring the sauce over the vegetable, fruit, and nut ingredients while it is hot helps prevent spoilage and maintain the crunchy texture of the ingredients.

Aging the ingredients at room temperature induces rapid fermentation of the pickle. (The room-temperature aging step S50)

After the room-temperature aging step, the ingredients (i.e., vegetables, fruits, and nuts) seasoned with the sauce are aged at a low temperature of 1° C. to 5° C. for 3 to 4 days.

In this case, when the temperature is lower than 1° C., the ingredients seasoned with the sauce may freeze to cause damage to the tissue structure thereof, and when the temperature is higher than 5° C., the ingredients may not ferment properly and may spoil.

When the ingredients are aged at the low temperature as described above, the ingredients ferment slowly to allow the sauce to fully permeate the ingredients, and the juice from the ingredients harmonizes with the sauce. (The primary low-temperature aging step S60)

After the primary low-temperature aging step, the ingredients mixed with the sauce are strained to separate a liquid from the ingredients (i.e., vegetables, fruits, and nuts). The liquid is a combination of the sauce and the juice from the ingredients.

Then, the liquid separated from the ingredients is boiled to 100° C. and cooled, poured back over the strained ingredients, sealed, and then aged at a low temperature of 1° C. to 5° C. for 4 to 5 days.

Herein, when the temperature is lower than 1° C., the ingredients seasoned with the sauce may freeze to cause damage to the tissue structure thereof, and when the temperature is higher than 5° C., the ingredients may not ferment properly and may spoil.

When the above process of boiling, cooling, pouring back, sealing, and then aging the liquid at the low temperature is repeated 2 to 3 times, a fermented pickle is made. (The secondary low-temperature aging step S70)

The fermented pickle made according to the current embodiment may be consumed quickly and easily by busy modern people who do not have much time for meals because it includes bite-sized vegetables, fruits, and nuts, and may provide various nutrients in terms of quality without individually preparing various vegetables, fruits, etc. for each meal because it includes various kinds of vegetables, fruits, and nuts which are rich in vitamins, minerals, proteins, fiber, and antioxidants.

Furthermore, the fermented pickle may have a low acidity and be consumed in larger quantities in one meal compared to existing pickles because it is made by mixing vinegar, water, sugar, and salt at a weight ratio of about 1:1:0.5:0.05. Thus, various nutrients required everyday may be sufficiently obtained from one meal in terms of quantity.

Meanwhile, the fermented pickle may provide various nutrients and aesthetic satisfaction based on food colors because it includes a mixture of various colored vegetables, fruits, etc., and have a unique flavor and retain intrinsic tastes and aromas of foods for a long time because the scent of the juice from the various vegetables, fruits, etc. is enriched over time through the aging steps S50, S60, and S70. The fermented pickle may be easily served with any food and satisfy the taste of everyone regardless of age or gender.

In addition, because the juice from the vegetables, fruits, etc. is sterilized and, at the same time, the liquid separated from the ingredients (i.e., vegetables, fruits, and nuts) is slightly boiled down by the secondary low-temperature aging step S70, the fermented pickle may be stored for a long time and have a luxurious and deep taste, unlike existing jangajji or pickles with a sharp flavor.

In the current embodiment, although rapid fermentation of the pickle is induced through the room-temperature aging step S50, the pickle may also be fermented only through the low-temperature aging steps S60 and S70 without using the room-temperature aging step S50.

In the current embodiment, although the process of boiling, cooling, pouring back, and aging the strained liquid is repeated 2 to 3 times in the secondary low-temperature aging step, the process may also be performed only once.

According to the present invention, because various kinds of vegetables and fruits are prepared in a uniform size, seasoned with a sauce made by mixing vinegar, water, sugar, and salt at a weight ratio of about 1:1:0.5:0.05, and then aged at low temperature, various nutrients may be provided quickly and easily and sufficient amounts of nutrients may be provided due to a low acidity of vinegar.

While the present invention has been particularly shown and described with reference to embodiments thereof, it will be understood by one of ordinary skill in the art that various changes in form and details may be made therein without departing from the scope of the present invention as defined by the following claims.

What is claimed is:

1. A method of making a fermented pickle, the method comprising:
a vegetable ingredient preparation step for preparing various kinds of vegetables in a uniform size;
a fruit ingredient preparation step for preparing various kinds of fruits in a uniform size;
a sauce preparation step for preparing a sauce by mixing 100 parts by weight of vinegar, 90 to 110 parts by weight of water, 40 to 60 parts by weight of sugar, and 4 to 6 parts by weight of salt; and
a primary low-temperature aging step for mixing the prepared ingredients with the sauce and aging the ingredients at 1° C. to 5° C. for 3 to 4 days.

2. The method of claim 1, further comprising a nut ingredient preparation step for preparing nuts in a uniform size.

3. The method of claim 1, further comprising a secondary low-temperature aging step for boiling a liquid separated from the various kinds of ingredients, cooling the liquid, pouring the liquid back over the various kinds of ingredients, and then aging the ingredients at 1° C. to 5° C. for 4 to 5 days.

4. The method of claim 1, wherein the various kinds of vegetables comprise celery, perilla leaves, lance asiabell roots, green plums, garlic, chili peppers, ginger, radishes, onions, cabbage (or red cabbage), cucumbers, various colored bell peppers, sweet peppers, garlic stems, and rosemary.

5. The method of claim 1, wherein the various kinds of fruits comprise apples, sweet persimmons, pears, peaches, bananas, and kiwifruit.
